(19) United States
(12) Patent Application Publication
(10) Pub. No.: US 2004/0117329 A1
(43) Pub. Date: Jun. 17, 2004

(54) Systems and methods for electronic claims processing

(76) Inventor: Mary Jane Crain, Fairfax, VA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/474,722

(22) PCT Filed: Apr. 15, 2002
(86) PCT No.: PCT/US02/11594

(51) Int. Cl. G06F 17/60; G06F 9/00; G06F 17/00

(52) U.S. Cl. 705/410; 705/4

(57) ABSTRACT

An embodiment of the invention provides a method for electronic claims processing. The method includes receiving information regarding a claim through an electronic form. The method further includes receiving digital data associated with the claim. The method further includes electronically transmitting the information and the digital data to an arbitrator. The method further includes electronically receiving a determination from the arbitrator.

RELATED APPLICATIONS

This application claims the benefit of a provisional application entitled “Online Claims Processing System,” filed Apr. 13, 2001 and assigned Ser. No. 60/283,360. The contents of the above application is relied upon and expressly incorporated herein by reference.

### BACKGROUND

1. Technical Field

The present invention relates generally to systems and methods for claims processing. More particularly, this invention relates to systems and methods for electronic claims processing.

2. Related Art

The U.S. Postal Service (USPS), an independent establishment of the executive branch of the U.S. Government, provides many features through a variety of document and package delivery services. The USPS, like many other organizations, has extensive claims processing requirements. When a parcel is damaged in transit, the receiver makes a claim. The claim is typically processed manually. The receiver fills out paperwork and brings the damaged parcel into a center. The center personnel look at the parcel and then forward the claim to a manual-processing center. If the processing center personnel wish to dispute a claim's validly, further investigation may be needed. However, often the damaged parcel is either unavailable or discarded by the time of the investigation. The personnel who originally looked at the damaged parcel may be unavailable due to relocation or retirement.

There are many problems with the manual system of claim processing. Because the manual-processing system is a multi-step process, it can often be slow, frustrating, and difficult to manage. Evidence may disappear before final review and personnel with knowledge of the events may become unavailable. Thus a solution to the problems of manual claim processing is needed. A solution may be to take advantage of the growing use of electronic media, such as digital images, and electronic networks for displaying the images.

The use of electronic media to convey information among networked users has undergone an enormous amount of growth in recent years. The ability to create and view data had gone through a period of expansion and become increasingly useful in business applications.

The Internet, fueled by the phenomenal popularity of the World Wide Web (WWW or the “web”), has also exhibited exponential growth over the past few years, giving many users access to an electronic network. To access this network, users need only standard computer equipment, such as a personal computer with a display and modem, and an Internet connection. Several types of Internet connections are available, including connections through Internet Service Providers (ISPs). To use an Internet connection from an ISP, for example, the user causes the personal computer to connect electronically to a computer at the ISP's facility using the modem and a communication channel, such as a standard telephone line, DSL line, or a CATV cable. The ISP's computer in turn provides the user with access to the Internet.

Through the Internet connection, the user accesses information on the web using a computer program called a “web browser,” such as the Netscape Navigator™ from Netscape Communications Corporation or Internet Explorer from Microsoft Corporation. To accomplish this, the user inputs to the web browser a Uniform Resource Locator (URL) identifying an object on the Internet, for example, a document containing claims processing information. The web browser retrieves the web page and displays it for the user.

Given that current manual claims processing systems have a number of drawbacks, as described above, new solutions are needed. By using digital image capture and online, or web based, forms, information can be saved and used in an improved claims processing system. Thus, in order to facilitate claim processing, it is desirable to provide systems and methods for electronic claims processing, by utilizing the Internet and digital recording media.

### SUMMARY

In accordance with the purpose of the present invention, as embodied and broadly described herein, the invention provides systems and methods for electronic claims processing.

In one embodiment consistent with the present invention, a method for electronic claims processing is provided. The method includes receiving information regarding a claim through an electronic form. The method further includes receiving digital data associated with the claim. The method further includes electronically transmitting the information and the digital data to an arbitrator. The method further includes electronically receiving a determination from the arbitrator.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 shows a block diagram of an exemplary system in which methods and system consistent with the invention may be implemented.

FIG. 2 shows an internal block diagram of an exemplary computer system in which methods and system consistent with the invention may be implemented.

FIG. 3 shows a block diagram of a claim form that can be used with methods and systems consistent with the invention.

FIG. 4 shows a flowchart of an exemplary method for performing electronic claims processing.

FIG. 5 shows a flowchart of another exemplary method for performing electronic claims processing.

### DETAILED DESCRIPTION

Reference will now be made to the present embodiments consistent with the invention, examples of which are illustrated in the accompanying drawings. Wherever possible, the same reference numbers will be used throughout the drawings to refer to the same or like parts. The described systems and methods relate to providing for electronic claims processing.

### Exemplary System

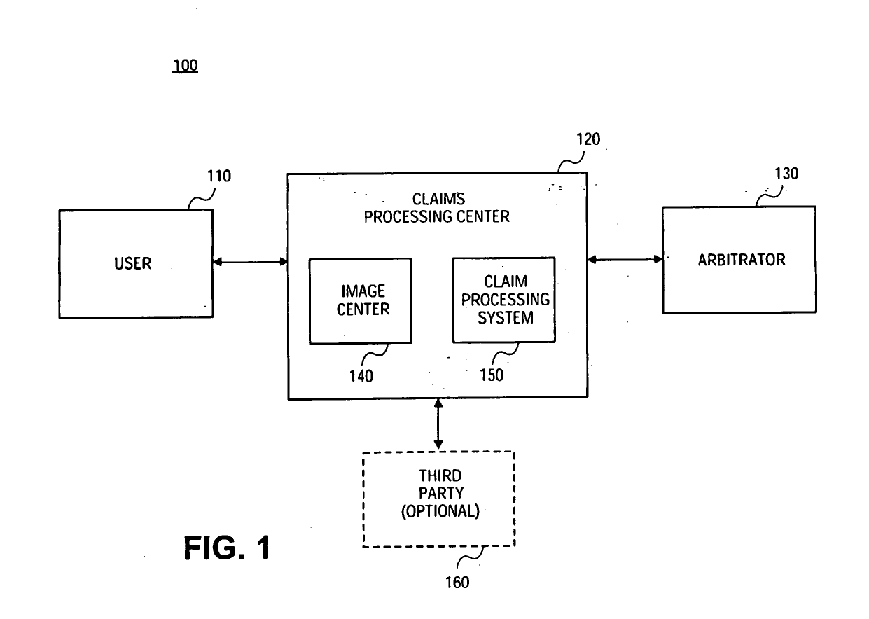

FIG. 1 is block diagram of an exemplary system 100 in which methods and apparatus consistent with the invention may be implemented. System 100 includes a user 110 and an arbitrator 130 connected by a claims processing center 120. Optionally, a third party 160 may be connected to the claims processing center 120. Claims processing center 120 includes an image center 140 and a claim processing system 150.

User 110 can be a receiver of merchandise who experiences an incident, such as a damaged parcel. User 110 may be an individual or a business. Arbitrator 130 may be a neutral third party, such as an arbitrator, adjustor, or adjudicator that can facilitate the response to the incident. Third party 160 may be the sender of the parcel. Third party 160 may also be the shipper of the parcel, such as USPS, United Parcel Service of America, Inc., or Federal Express®. The incident may be damage to the parcel, which leads to a claim by the user for compensation for the damage, such as monetary compensation or the replacement of merchandise.

User 110, arbitrator 130, and third-party 160 may use a personal computer, such as Apple PowerMacintoshes or Pentium-based personal computers running a version of the Windows operating system, workstation, or other appropriate types of computers. The connection between claims processing center 120 and the computers used by user 110, arbitrator 130, and third party 160 may be through a network which is TCP/IP based, wireless, or any kind of digital network connection, such as the Internet, a wide area network (WAN), a local area network (LAN) or a proprietary network. The communication can be conducted through a web-based environment in which the communications are transmitted via HTTP protocol.

As shown in FIG. 1, claims processing center 120 may have two parts: image center 140 and claim processing system 150. In one embodiment, claims processing center 120 is a computer-based system that facilitates claim processing. In another embodiment, claims processing center 120 uses physical locations to facilitate claim processing. Image center 140 and claim processing system 150 could be separate systems or part of one integrated center.

Image center 140 may be a physical site that is constructed to generate digital data. The digital data maybe still images of a damaged parcel taken from different viewpoints, audio recordings, digital video recordings, computer simulations of events, or any other type of digital data related to a claim. Image center 140 may include devices for generating digital data, such as digital cameras, video recorders, audio recorders, and computers running software that enables the generation of computer simulations. Image center 140 could be found in trusted locations such as post offices, banks, or other locations. The physical site may also include personnel to help user 110 generate the digital data. In another embodiment, image center 140 is an image-processing center that is capable of receiving digital data from user 110. The digital data may be an image taken by a digital camera connected to a computer used by user 110 and sent to image center 140. Image center 140 may include a processing system for verifying the image and to insure that improper manipulations have not been made to the digital data.

Claim processing system 150 may be a computer system. Claims processing system 150 generates claim forms, receives claim data from user 110, stores claim data, links claim data to digital data, creates claim reports, forwards claim reports to arbitrators, receives determination reports from arbitrators, and publishes claim results. Claim processing system 150 handles all the processing necessary to allow for the determination of responses to a claim made by user 110. Claims processing center 150 may be implemented as a web site which displays web-based forms for which information can be entered on-line, a computer program running on a computer at a physical site that allows for personal to enter information for non-computer savvy people, or a physical location that allows users to enter the information for themselves at the locations. Claim processing system 150 may be one computer or a number of computers connected together to form a system. Each computer can control specific tasks or they can all function independently.

In one embodiment, claims processing center 120 comprises a postal kiosk locate, for example, in a post office, a shopping mall, an office-building lobby, or other mutable locations. Attached to the postal kiosk is a digital camera performing the function of image center 140, describe above. Inside the postal kiosk is a computer system performing the function of claims processing system 150. Claims processing system 150 generates electronic forms for a user to fill out, links the images captured from the digital camera to the form, and facilitates communication with arbitrator 130 through a network connection.

### Exemplary Computer System

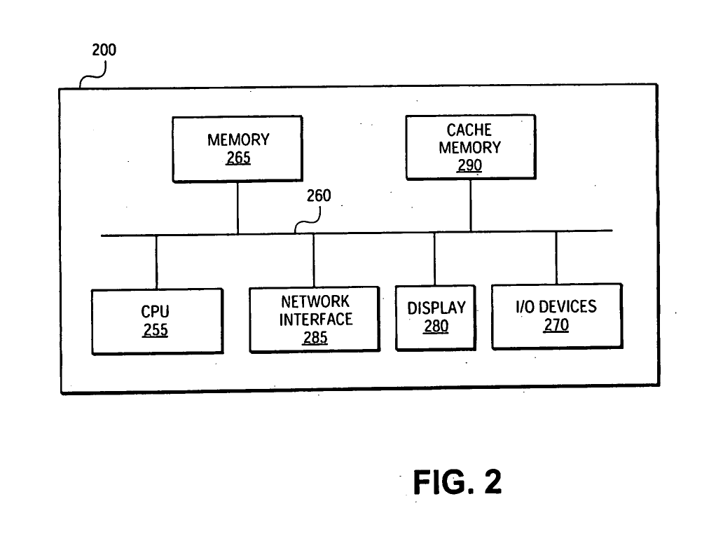

FIG. 2 is an internal block diagram of an exemplary-computer system 200 in which methods and system consistent with the invention may be implemented. Computer system 200 may represent the internal components of claim processing system 150, image center 140, claims processing center 120 or the computers that may be used by user 110, arbitrator 130, or third party 160 in FIG. 1.

Computer system 200 includes several components all interconnected via a system bus 260. Bus 260 may be, for example, a bi-directional system bus that connects the components of computer system 200. For example, bus 260 may contain thirty-two address lines for addressing a memory 265 and thirty-two bit data lines for transferring data among the components. Alternatively, multiplex data/address lines may be used instead of separate data and address lines. Computer system 200 may communicate with other computing systems via network interface 285, examples of which include Ethernet or dial-up telephone connections.

Computer system 200 contains a central processing unit (CPU) 255 connected to a memory 265. CPU 255 may be a microprocessor such as the Pentium® family microprocessors manufactured by Intel Corporation. However, any other suitable microprocessor, micro-, mini-, or mainframe computer may be used. Memory 265 and cache memory 290 may include a random access memory (RAM), a read-only memory (ROM), a video memory, or mass storage. Memory 265 may contain a program, an application programming interface (API), and other instructions for performing the methods consistent with the invention.

Computer system 200 may also receive input via input/output (I/O) devices 270, which may include a keyboard, pointing device, or other like input devices. Computer system 200 may also present information and interfaces via display 280.

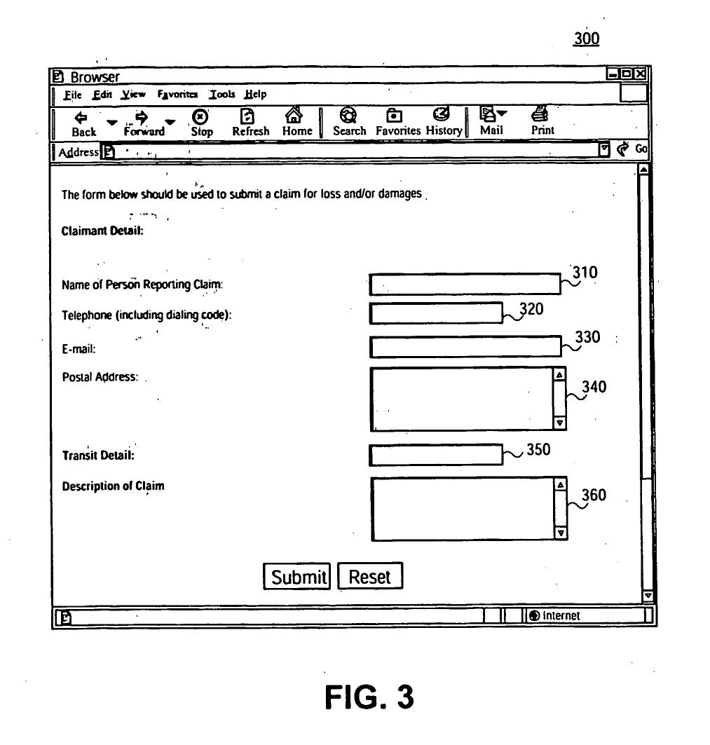

FIG. 3 is a block diagram of an exemplary claim form 300. Claim form 300 allows for the,entry of information necessary for user 110 to make a claim request. Claim form, 300 may include entry boxes for Claimant Details, such as the name of Person Reporting claim 310, Telephone number (including dialing code) 320, E-mail address 330, Postal Address 340, Transit Detail 350, and Description of claim 360.

Claim form 300 may include other entry boxes that are not shown for gathering any other details necessary for processing a claim. Claim form 300 may be an electronic form that appears as a web page on a web browser. In an alternative embodiment claim form may be an electronic form that appears on a computer in claims processing center 120. Claim form 300 may be a standard claim form used by claims processing center 120 or it may be a form generated specifically for each claimant based on the specifics of the claim.

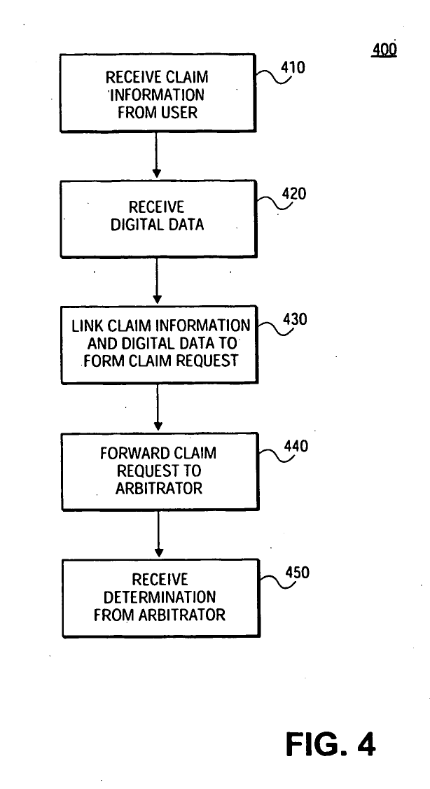

FIG.4 shows a flowchart of an exemplary method for performing electronic claims processing. The claim processing center receives claim information from user 110 (step 410). The claim information can be received through user 110 entering data into an electronic claim form 300. Digital data related to the claim is received (step 420). The digital data may be an image file, a video file, a computer based simulation, an audio file or any other type of digital data that may be helpful for to the arbitrator in processing the claim. The digital data and the claim information are then associated, or linked, to form a complete claim request (step 430). The claim request is then forwarded to an arbitrator (step 440). The claim request can be forwarded to arbitrator 130 by electronically transmitting to the arbitration an email message that includes a hyperlink to a claim complete claim request page, which includes an area for arbitrator to enter a determination. In an alternate embodiment, the claim request can be a “live” claim request and the arbitrator can view the claim information being entered and the linked digital data and forwarding the claim request to the arbitrator involves informing the arbitrator of the need to view the claim information.

A determination is then electronically received from the arbitrator (step 450). The determination from the arbitrator can be in the form of an electronic written report or a simple check of YES or NO in a check box viewable by the arbitrator. The determination from the arbitrator completes the claim process. After receiving the determination, the user can be informed of the result by, for example, electronic publication.

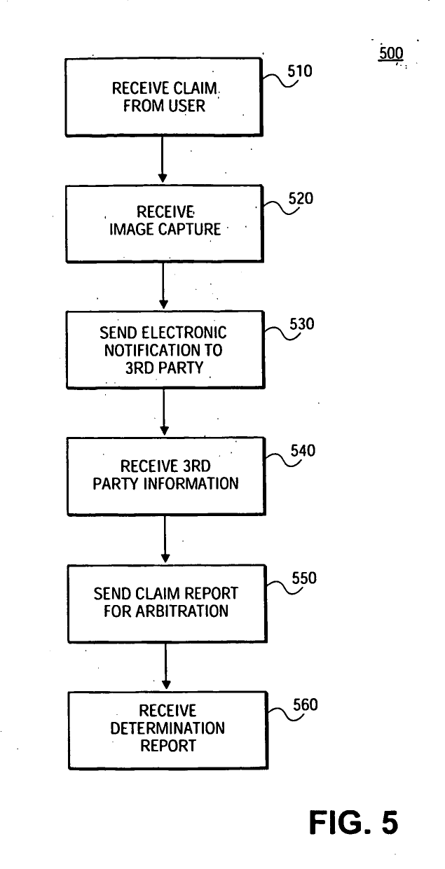

FIG. 5 shows a flowchart of an alternate exemplary method for performing electronic claims processing. In the alternate exemplary method, a third party, such as a sender, is part of the claim process. The claim processing center receives a claim from user 110 (step 510). For example, the claim may be for a shipment of glassware that arrived damaged. An image file is received (step 520). The image file may include an image of the box containing the glassware and an image of the damaged glassware. In another embodiment, if a carrier independently notices damage to the outside of a package, the damaged package may be imaged it before the package is delivered. Thus a record may be created to be used in the arbitration process. In yet another embodiment, the carrier could image all packages when they are picked up and when they are delivered, and this information may be stored for a set period of time.

Electronic notification is sent to third party 160 (step 530). The claim processing system may send a copy of the claim from user 110 to the sender of the glassware, third party 160. Information is then received from the third party 160 (step 540). Third party 160 information may include the sender's shipping information, the sender's insurance information, the value of the merchandise, and/or the sender's standard shipping procedure. The claim report is then sent for arbitration (step 550). The claim report may include the original claim request from the user, images of the damaged glassware and shipping material, and the third party sender's information. The arbitrator may use this information to come to a determination of how to respond to the claim. The arbitrator may determine that the glassware was damaged in transit, the receiver damaged the glassware, the glassware was not properly packaged according to sender procedure, or any other type of claim determination, including value of loss and how to respond to the loss.

The arbitrator creates a determination report based on their findings, which is received by claims processing center 120 (step 560). Once received, the parties can view the results, along with all the factual inputs on-line.

In another embodiment, the method may be applied to the auto insurance industry. Insurance companies may equip remote sites or garages with on-line video deices or still cameras, forming their own system of image centers 140. A user may fill out an on-line form, then may be directed to take the damaged car to claims processing center 120, which is located,in a pre-selected garage. The car may be imaged from all angles and even underneath. The images and form may be sent to the arbitrator 130. In the arbitrator's determination report, authorization to perform the work may be granted. This process may reduce the cost of having claims adjustors at multiple remote sites.

In another embodiment every U.S. Post Office may be equipped with an inexpensive digital camera. When a customer picks up a package at the Post Office and note damage to the package, the customer may complete the claims process before leaving left the Post Office, by having the packaged imaged, the form filled out and arbitration happen by use of a postal kiosk or the help of postal employees.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for processing a claim comprising:
receiving information regarding the claim through an electronic form;
receiving digital data associated with the claim;
electronically transmitting the information and the digital data to an arbitrator; and
electronically receiving a determination from the arbitrator.

2. The method of claim 1, further comprising:
electronically publishing the determination.

3. The method of claim 1, further comprising:
linking the claim and the digital data to form a claim request.

4. The method of claim 1, wherein the electronic form is a web page on the Internet.

5. The method of claim 1, wherein the electronic form is presented at a claims processing center.

6. The method of claim 1, wherein the digital data is received from an image center.

7. The method of claim 1, wherein the digital data is received from the user.

8. The method of claim 1, wherein the digital data is one of a still image file, a video file, a computer-based simulation, or an audio file.

9. A method for processing a claim comprising:
receiving user information regarding the claim from a user via an electronic form;
electronically receiving digital data associated with the claim;
forwarding the claim and the digital data to a third party;
receiving third party information from the third party;
forwarding the claim, the digital data, and the third party information to an arbitrator; and
receiving a determination from the arbitrator.

10. The method of claim 9, further comprising:
linking the claim, the digital data, and the third party information to form a claim report.

11. The method of claim 9, further comprising:
publishing the determination, wherein publishing comprises
electronically transmitting the determination to the user and the third party.

12. The method of claim 9, wherein the digital data is one of a still image file, a video file, a computer-based simulation, or an audio file.

13. The method of claim 9, wherein the user is a receiver of damaged goods.

14. The method of claim 9, wherein the third party is the sender of the goods.

15. The method of claim 9, wherein the arbitrator is an independent third party.

16. The method of claim 9, wherein the third party information is information about the transit of the goods.

17. A system for processing claims, the system comprising:
a processing system for electronically receiving information regarding a claim;
an image, center for generating at least one image associated with the claim; and
a center for electronically transmitting the information and the at least one image to an arbitrator and for electronically receiving a determination regarding the claim by the arbitrator.

18. The system of claim 17, further comprising:
a publisher for publishing the determination.

19. A system for processing claims, the system comprising:
an input component for receiving claim information;
a central database for storing the claim information;
a receiving component for receiving image data from a plurality of image capture device positioned at various locations remote from the central database;
a web-page for permitting an arbitrator to view captured images and the associated data; and
a reporting component for electronically receiving a determination regarding the claim from the arbitrator.

20. A claims processing system comprising:
a receiver for electronically receiving a claim request from a user,
an image center for creating a digital image file related to the claim request; and
a processing center for electronically transmitting the claim request and the digital image file to an arbitrator and for electronically receiving a determination from the arbitrator, and for electronically publishing the determination.
